(19) United States
(12) Patent Application Publication
(10) Pub. No.: US 2023/0259184 A1
(43) Pub. Date: Aug. 17, 2023

(54) LOGIC CONTROLS FOR GRAPHICS CARD AIR MOVING DEVICES

(71) Applicant: HEWLETT-PACKARD DEVELOPMENT COMPANY, L.P., Spring, TX (US)

(72) Inventors: Andrew L. Wiltzius, Fort Collins, CO (US); Sheng-Lung Liao, Taipei City (TW); Robert Lee Crane, Fort Collins, CO (US); Jonathan D. Bassett, Fort Collins, CO (US)

(21) Appl. No.: 17/673,916

(22) Filed: Feb. 17, 2022

(51) Int. Cl. G06F 1/20; G06F 13/42; G06T 1/20

(52) U.S. Cl. CPC G06F 1/206; G06F 13/4221; G06F 13/4208; G06T 1/20; G06F 2213/0026

(57) ABSTRACT

In example implementations, an apparatus is provided. The apparatus includes an interface, a graphics card connected to the interface, and a controller communicatively coupled to the interface. The graphics card includes an air moving device. The controller is to send a logic control to the graphics card to activate the air moving device in response to a performance parameter.

### BACKGROUND

Computing devices can be used to execute various applications and programs. A processor is deployed in a computing device to execute the applications and programs. The computing device can have additional components that can help execute the applications, such as memory, graphics processors, and the like.

Discrete graphics cards can be installed to provide additional graphical processing power. The discrete graphics cards can generate large amounts of heat. Air moving devices (e.g., fans, blowers, and the like) are often included in the discrete graphics cards to help cool the graphics processors during operation.

### BRIEF DESCRIPTION OF THE DRAWINGS

FIG. 1 is a block diagram of an example an apparatus with a graphics card having an air moving device that can be controlled via logic controls from a controller of the present disclosure;

FIG. 2 is another block diagram of another example apparatus with a graphics card having an air moving device that can be controlled via logic controls from a controller of the present disclosure;

FIG. 3 is a block diagram of an example graphics card having an air moving device connected to a Peripheral Component Interface Express (PCIe) interface and controlled by a controller of the present disclosure;

FIG. 4 is a flow chart of an example method to control an air moving device of a graphics card via logic controls of the present disclosure; and

FIG. 5 is an example non-transitory computer readable storage medium storing instructions executed by a processor to control an air moving device of a graphics card via logic controls of the present disclosure.

### DETAILED DESCRIPTION

Examples described herein provide an apparatus and method to control an air moving device of a graphics card using logic control signals. As discussed above, computing devices can be used to execute various applications and programs. Discrete graphics cards can be installed to provide additional graphical processing power. The discrete graphics cards can generate large amounts of heat. Air moving devices are often included in the discrete graphics cards to help cool the graphics processors during operation.

Currently, the air moving device on a discrete graphics card is controlled based on operation of the graphical processing unit (GPU) on the graphics card. The air moving device can help cool the GPU during operation of the GPU to maximize performance.

In some instances, the air moving device can be controlled by adjusting an amount of power delivered to operate the air moving device. For example, more voltage can be delivered to increase the air moving device's speed or less voltage can be delivered to decrease the air moving device's speed. In another instance, a Pulse-Width Modulation (PWM) signal is provided to the air moving device to either increase or decrease the air moving device's speed.

However, air moving device controls that are based on physical delivery of power, or PWM signals, may operate within the confines of the operating system. In addition, using power, or PWM signals, to control the air moving device's speed prevents the air moving device control from being tied into other sensors within the computing device (e.g., thermal sensors).

The present disclosure provides logic controls to control the air moving device of a graphics card. For example, a controller communicatively coupled to the interface connected to the graphics card can be modified to transmit logic controls that can be understood by the graphics card. The logic controls can be used to turn the air moving device on and off or to control the speed of the air moving device. Using the logic controls may provide controls for the graphics card air moving device outside of the operating system and incorporate the air moving device control based on other sensors or applications within the computing device.

For example, a mass storage device, such as a hard disk drive (HDD), may be located adjacent to the graphics card. A temperature sensor may detect that the storage device is overheating. The controller may send a logic control to the graphics card to activate the air moving device that is integrated into the graphics card to cool the storage device, independent of the operation of the GPU on the graphics card. In another example, to maximize performance of the computing system, it may be beneficial to have all the air moving devices within a chassis of the computing system on. Thus, the controller may send a logic control to the graphics card to activate the air moving device integrated into the graphics card to optimize performance. Thus, the present disclosure allows the air moving device of a graphics card to be controlled independently of the operation of the GPU on the graphics card using logic controls.

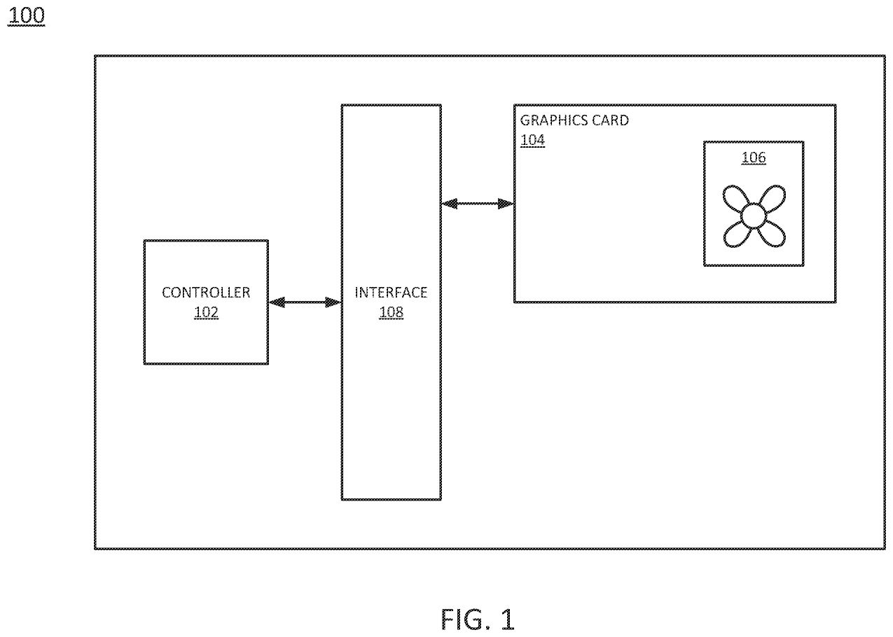

FIG. 1 illustrates an example apparatus 100 of the present disclosure. In an example, the apparatus 100 may be a computing device or a computing system. For example, the apparatus 100 may be a desktop computer, a laptop computer, a tablet computer, and the like.

It should be noted that apparatus 100 has been simplified for ease of explanation. Although various example components are illustrated in FIG. 1, it should be noted that the apparatus 100 may include additional components that are not shown. For example, the apparatus 100 may include input/output devices (e.g., a display, a monitor, a keyboard, a mouse, a trackpad, and the like), a power supply, various interfaces (e.g., a universal serial bus (USB) interface), communications interfaces (e.g., a wired or wireless communication interface such as WiFi, Ethernet, and the like), memory, solid state drive, a hard disk drive, and so forth.

In an example, the apparatus 100 may include a controller 102, a graphics card 104, and an interface 108. The graphics card 104 may be a discrete graphics card 104 that is connected to the interface 108. The controller 102 may communicate with and control the operation of the graphics card 104 via logic signals transmitted across the interface 108.

In an example, the graphics card 104 may include an air moving device 106. Although a single graphics card 104 and a single air moving device 106 are illustrated in FIG. 1, it should be noted that any number of graphics cards 104 with any number of air moving devices 106 may be deployed. The air moving device 106 may be a fan, a blower, or any other type of mechanical device that can circulate air. The air moving device 106 may provide cooling for the graphics card 104 during operation. Graphics cards can generate a large amount of heat during operation. The air moving device 106 may provide cooling to prevent the graphics card 104 from overheating and failing.

The air moving device 106 can be controlled with a physical signal in conjunction with operation of the graphics card 104. For example, a power signal, or PWM signal, may be sent to the air moving device 106 to turn the air moving device on and off. The physical signals are typically set by the basic input/output (BIOS) of the apparatus 100 during a boot sequence. However, using physical signals may limit the usefulness of the air moving device 106 and/or the ability to control the air moving device 106 based on other sensors or performance parameters of the apparatus 100.

The present disclosure provides out-of-band signals or logic control signals that can be used to control the air moving device 106. As a result, the air moving device 106 of the graphics card 104 can be controlled based on a variety of different performance parameters and/or sensors of the apparatus 100.

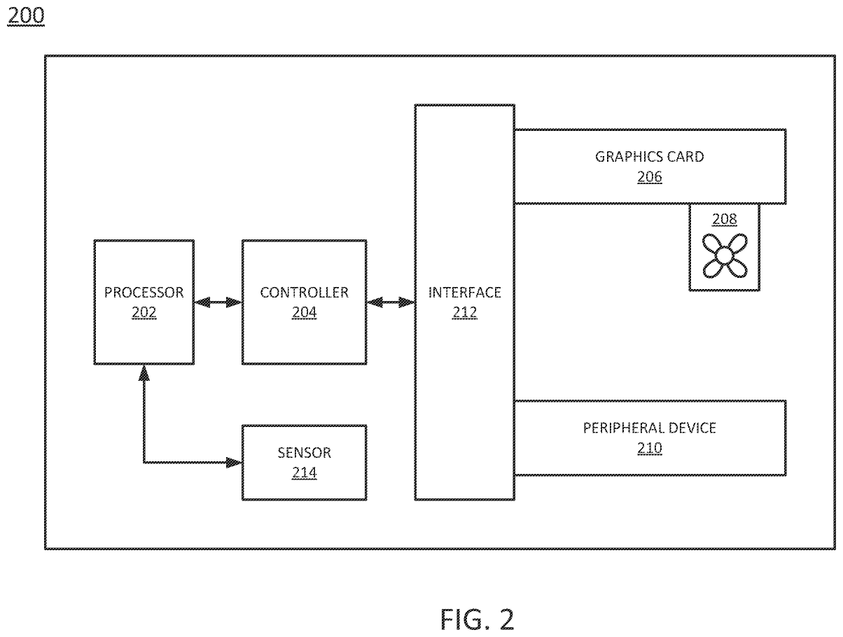

FIG. 2 illustrates an example apparatus 200 of the present disclosure. In an example, the apparatus 200 may be a computing device or a computing system. For example, the apparatus 200 may be a desktop computer, a laptop computer, a tablet computer, and the like.

It should be noted that apparatus 200 has been simplified for ease of explanation. Although various example components are illustrated in FIG. 2, it should be noted that the apparatus 200 may include additional components that are not shown. For example, the apparatus 200 may include input/output devices (e.g., a display, a monitor, a keyboard, a mouse, a trackpad, and the like), a power supply, various interfaces (e.g., a universal serial bus (USB) interface), communications interfaces (e.g., a wired or wireless communication interface such as WiFi, Ethernet, and the like), memory, solid state drive, a hard disk drive, and so forth.

In an example, the apparatus 200 may include a processor 202, a controller 204, a graphics card 206, a peripheral device 210, an interface 212, and a sensor 214. The processor 202 may be a central processing unit (CPU) that controls operation of various components within the apparatus 200. In an example, the processor 202 may be a general purpose processor or an application specific processor, such as one that is dedicated to the health management of the apparatus 200. The processor 202 may be communicatively coupled to the controller 204 and a sensor 214.

The sensor 214 may be any type of sensor that can measure a performance of a particular component within the apparatus 200. For example, the performance of the particular component may include a temperature of the component, an operating speed or performance of the component, and the like.

For example, the sensor 214 may be a thermal sensor. The thermal sensor may measure a temperature of the peripheral device 210. For example, temperature criteria, such as a maximum temperature threshold, may be set for the peripheral device 210. The temperature criteria may be stored in memory (not shown). When the temperature of the peripheral device 210 matches the temperature criteria, an air moving device 208 of the graphics card 206 may be controlled to help cool the peripheral device 210, as discussed in further detail below.

In another example, the sensor 214 may measure an operating speed or performance, such as a clock speed (e.g., operating frequency), of the processor 202. An operating speed criteria may be stored in memory (not shown). When a maximum performance is desired and the speed or performance of the processor 202 matches the operating speed criteria, the air moving device 208 of the graphics card 206 may be controlled to help cool the inside of the apparatus 100 to maximize performance of the processor 202.

Although a single sensor 214 is illustrated in FIG. 2, it should be noted that more than one sensor 214 may be deployed. For example, a thermal sensor and a processor clock speed sensor may be deployed in the apparatus 200, or multiple thermal sensors may be deployed in the apparatus 200. It should be noted that sensor 214 is not limited to measuring temperature or clock speed, but can be any type of sensor, for any component within apparatus 200.

The controller 204 may be a dedicated integrated circuit, chipset or processor that controls operation of the interface 212. The controller 204 may send logic signals to various devices connected to the interface 212 in response to signals sent from the processor 202. In an example, the graphics card 206 and the peripheral device 210 may be connected to the interface 212.

In an example, the peripheral device 210 may be connected to a slot of the interface 212 that is adjacent to the slot of the graphics card 206. The peripheral device 210 may be a memory card, a solid state drive, another graphics card, and the like.

The controller 204 may send logic signals to control operation of the air moving device 208 in response to a performance parameter being met. In other words, the controller 204 can activate the air moving device 208 independently from the operation of the graphics card 206. Said another way, the controller 204 may use out-of-band signals or logic signals to control the air moving device 208 in response to measurements from the sensor 214.

As noted above, the performance parameter may be a temperature of the peripheral device 210, an operating speed of the processor 202, and the like. In an example, the sensor 214 may be a thermal sensor that measures the temperature of the peripheral device 210. The sensor 214 may detect that the temperature of the peripheral device 210 matches a stored temperature criteria. A signal may be sent to the processor 202. The processor 202 may cause the controller 204 to send a logic signal to activate the air moving device 208.

When the temperature of the peripheral device no longer matches the temperature criteria, the sensor 214 may send a second signal to the processor 202. The processor 202 may cause the controller 204 to send a logic signal to deactivate the air moving device 208.

In another example, the performance parameter may be an operating speed or performance, such as a clock speed (e.g., operating frequency) of the processor 202. For example, a user may want to set the performance parameter to a maximum clock speed. To achieve the maximum clock speed, the processor 202 should be kept cool to prevent overheating. When the sensor 214 detects that the clock speed of the processor 202 matches a stored operating speed criteria, the sensor 214 may send a signal to the processor 202. The processor 202 may then cause the controller 204 to send a logic signal to the graphics card 206 to activate the air moving device 208. The air moving device 208 can be deactivated when the maximum performance of the processor 202 is no longer desired.

Although a few example performance parameters are provided above, it should be noted that other performance parameters may be monitored and may be within the scope of the present disclosure. For example, other performance parameters that could be monitored to control operation of the air moving device 208 may include overall airflow in a chassis of the apparatus 200, a timer to cycle the air moving device 208 periodically to prevent dust build up that can create electrostatic charge dissipation within the chassis, and the like.

In an example, the performance parameter may be set via an application shown on a user interface of a display (not shown). For example, the application may allow a user to set the desired thresholds for the performance parameter. Thus, the logic signals sent by the controller 204 may allow the air moving device 208 to be controlled outside of using physical signals or using settings in the BIOS of the apparatus 200.

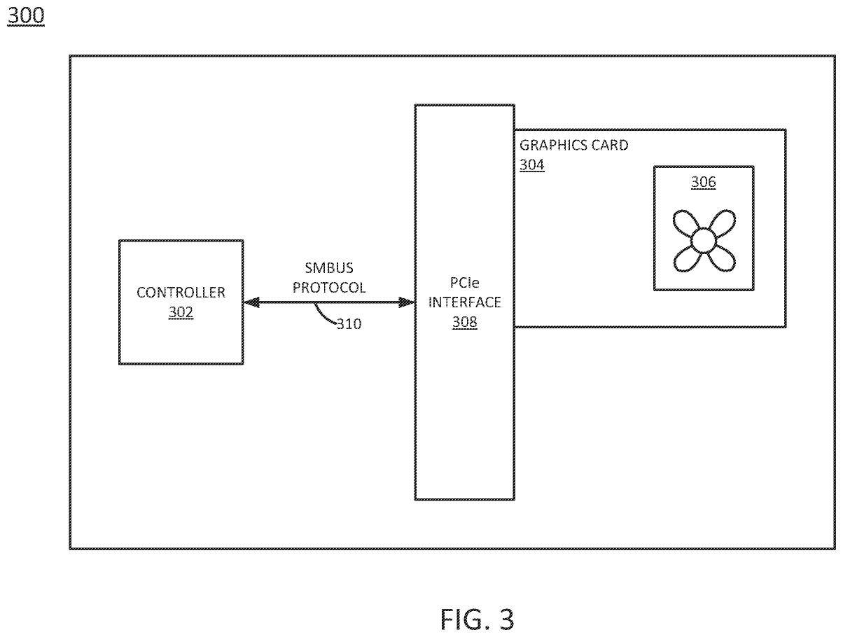

FIG. 3 illustrates an example apparatus 300 of the present disclosure. In an example, the apparatus 300 may be a computing device or a computing system. For example, the apparatus 300 may be a desktop computer, a laptop computer, a tablet computer, and the like.

It should be noted that apparatus 300 has been simplified for ease of explanation. Although various example components are illustrated in FIG. 3, it should be noted that the apparatus 300 may include additional components that are not shown. For example, the apparatus 300 may include input/output devices (e.g., a display, a monitor, a keyboard, a mouse, a trackpad, and the like), a power supply, various interfaces (e.g., a universal serial bus (USB) interface), communications interfaces (e.g., a wired or wireless communication interface such as WiFi, Ethernet, and the like), memory, solid state drive, a hard disk drive, and so forth.

FIG. 3 illustrates a more specific example of an interface 308. For example, the apparatus 300 may include a controller 302, a graphics card 304, and an interface 308. The interface 308 may be a Peripheral Component Interconnect Express (PCIe) interface. The graphics card 304 may be connected to the interface 308 via a slot of the PCIe interface.

In an example, the controller 302 may be a host controller that controls operation of the interface 308. The controller 302 may use logic signals 310 that are compatible with the PCIe interface and/or the graphics card 304. For example, some logic signals may be assigned to activate, deactivate, or change a speed of an air moving device 306 coupled to the graphics card 304. In an example, the logic signal 310 may be a system management bus (SMBus) protocol that is compatible with the graphics card 304. Different SMBus protocol signals may be used to activate the air moving device 306, deactivate the air moving device 306, or change the speed of the air moving device 306.

Thus, the present disclosure provides an apparatus that can use logic signals to control operation of an air moving device of a graphics card independently from the operation of the graphics card. The ability to control the air moving device with logic signals may allow use of the air moving device with other sensors that may be within the computing system and outside of a BIOS control of the computing system. Thus, control of the air moving device on the graphics card may help to cool peripheral components that are adjacent to the air moving device on the graphics card, improve overall performance of the computing system, and the like.

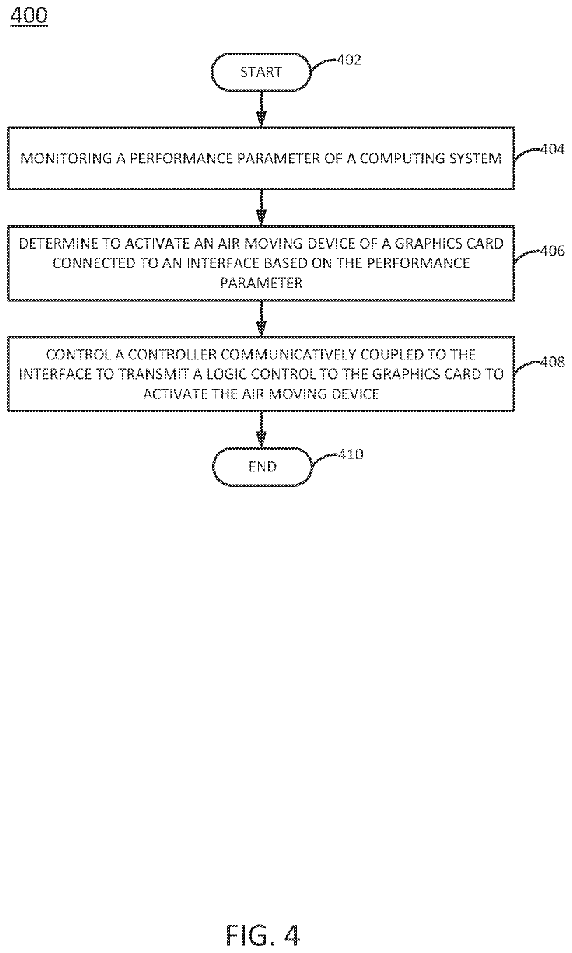

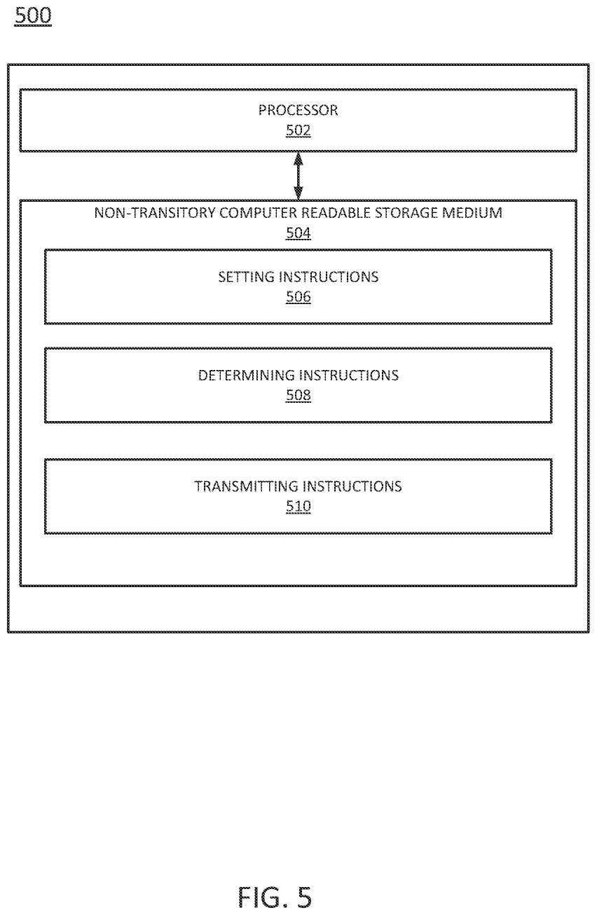

FIG. 4 illustrates a flow diagram of an example method 400 for controlling an air moving device of a graphics card via logic controls of the present disclosure. In an example, the method 400 may be performed by the apparatus 100 illustrated in FIG. 1, the apparatus 200 illustrated in FIG. 2, the apparatus 300 illustrated in FIG. 3, or the apparatus 500 illustrated in FIG. 5, and described below.

At block 402, the method 400 begins. At block 404, the method 400 monitors a performance parameter of the computing system. For example, the performance parameter may be an operating temperature of a component or peripheral device within the computing system, an operating speed or performance (e.g., an operating frequency) of the processor/CPU, and the like.

The performance parameter may be monitored by a sensor. For example, the sensor may be a thermal sensor, a clock speed sensor, and the like. In an example, multiple sensors may be deployed to monitor a plurality of performance parameters simultaneously (e.g., temperature and clock speed).

At block 406, the method 400 determines to activate an air moving device of a graphics card connected to an interface based on the performance parameter. In an example, the performance parameter may be monitored against criteria that is stored for the performance parameter. For example, for an operating temperature, the thermal sensor may measure the temperature of a component and compare the measured temperature to a stored temperature criteria for the component. If the temperature matches the criteria, the computing system may determine that the air moving device of the graphics card should be activated independently of the operation of the graphics card.

At block 408, the method 400 controls a controller communicatively coupled to the interface to transmit a logic control to the graphics card to activate the air moving device. For example, a controller that controls operation of the interface may send an out-of-band logic signal to activate the air moving device on the graphics card.

In an example, the interface may be a PCIe interface. The logic signal may be in a protocol that is understood by the graphics card. For example, a SMBus protocol may be used. Different SMBus protocol signals may be assigned to control signals to activate the air moving device, deactivate the air moving device, or change a speed of the air moving device. The appropriate logic control signal can be transmitted to the graphics card via the PCIe interface. The graphics card may then translate the control signal into the appropriate control of the air moving device (e.g., activating the air moving device). At block 410, the method 400 ends.

FIG. 5 illustrates an example of an apparatus 500. In an example, the apparatus 500 may be the apparatus 100, 200, or 300. In an example, the apparatus 500 may include a processor 502 and a non-transitory computer readable storage medium 504. The non-transitory computer readable storage medium 504 may include instructions 506, 508, and 510 that, when executed by the processor 502, cause the processor 502 to perform various functions.

In an example, the instructions 506 may include setting instructions 506. For example, the instructions 506 may set activation of an air moving device of a graphics card connected to an interface of the apparatus based on a performance parameter. For example, the performance parameter may be based on a temperature criteria for a peripheral device or may be to maximize performance of the processor 502.

The instructions 508 may include determining instructions. For example, the instructions 508 may determine the performance parameter has been met. For example, a thermal sensor may monitor a temperature of a peripheral device adjacent to the graphics card or the clock speed of the processor may be tracked. When the temperature matches the temperature criteria or when the operating speed of the processor matches the operating speed criteria, the performance parameter may be met.

The instructions 510 may include transmitting instructions. For example, the instructions 510 may transmit a logic control signal to the graphics card to activate the air moving device in response to the performance parameter being met. For example, a logic control signal may be used to transmit a control signal to activate the air moving device on the graphics card. The logic control signal may be an out-of-band signal that does not rely on BIOS configurations or operating system software. Rather, the logic control may be able to activate the air moving device using other sensors or information that can be collected by the processor.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An apparatus, comprising:
an interface;
a graphics card connected to the interface, the graphics card including an air moving device; and
a controller communicatively coupled to the interface, the controller to send a logic control to the graphics card to activate the air moving device in response to a performance parameter.

2. The apparatus of claim 1, wherein the interface comprises a Peripheral Component Interconnect Express (PCIe) interface.

3. The apparatus of claim 2, wherein the controller comprises an embedded controller connected to the PCIe interface.

4. The apparatus of claim 3, wherein the logic control comprises a system management bus (SMBus) protocol that is understood by the graphics card.

5. The apparatus of claim 1, wherein the controller is modified to associate air moving device controls with a plurality of different logic controls.

6. The apparatus of claim 1, further comprising:
a peripheral component located adjacent to the graphics card; and
a thermal sensor to monitor a temperature of the peripheral component.

7. The apparatus of claim 6, wherein the performance parameter comprises a temperature measured by the thermal sensor that matches a temperature criteria of the peripheral component.

8. The apparatus of claim 1, wherein the performance parameter comprises maximizing a performance counter of a processor.

9. A method, comprising:
monitoring, by a processor of a computing system, a performance parameter of the computing system;
determining, by the processor, to activate an air moving device of a graphics card connected to an interface based on the performance parameter; and
controlling, by the processor, a controller communicatively coupled to the interface to transmit a logic control to the graphics card to activate the air moving device.

10. The method of claim 9, wherein the performance parameter comprises a temperature of a mass storage device located adjacent to the graphics card.

11. The method of claim 9, wherein the performance parameter comprises a change to a performance mode selected by a user.

12. The method of claim 9, wherein the logic control comprises a protocol that is compatible with a communication protocol of the graphics card.

13. The method of claim 12, wherein the communication protocol comprises a system management bus (SMBus) protocol.

14. The method of claim 9, wherein the air moving device of the graphics card is activated independently from an operation of a graphical processing unit of the graphics card.

15. The method of claim 9, further comprising:
determining, by the processor, to deactivate the air moving device of the graphics card based on the performance parameter; and
controlling, by the processor, the controller to transmit a second logic control to the graphics card to deactivate the air moving device.

16. A non-transitory computer readable storage medium encoded with instructions which, when executed, cause a processor of an apparatus to:
set activation of an air moving device of a graphics card connected to an interface of the apparatus based on a performance parameter;
determine the performance parameter has been met; and
transmit a logic control signal to the graphics card to activate the air moving device in response to the performance parameter being met.

17. The non-transitory computer readable storage medium of claim 16, wherein the performance parameter comprises a temperature criteria of a peripheral component installed adjacent to the graphics card.

18. The non-transitory computer readable storage medium of claim 16, wherein the performance parameter comprises a user selected performance mode.

19. The non-transitory computer readable storage medium of claim 16, wherein the logic control signal comprises an out-of-band control signal.

20. The non-transitory computer readable storage medium of claim 16, wherein the logic control signal is to set a desired air moving device speed based on the performance parameter.
